(19) United States
(12) Patent Application Publication
(10) Pub. No.: US 2025/0220368 A1
(43) Pub. Date: Jul. 3, 2025

(54) Replaceable Wax Guard Kit

(71) Applicant: NOVIDAN, INC., GOLDEN VALLEY, MN (US)

(72) Inventors: TOM BERGNER, BLOOMINGTON, MN (US); PETE SALMI, MOUND, MN (US)

(21) Appl. No.: 18/401,707

(22) Filed: Jan. 1, 2024

Related U.S. Application Data
(60) Provisional application No. 63/421,982, filed on Nov. 2, 2022.

(51) Int. Cl. H04R 25/00

(52) U.S. Cl. CPC H04R 25/654; H04R 2460/11; H04R 2460/17

(57) ABSTRACT

The invention relates to apparatuses and processes for replacing a used wax guard with a new wax guard for a hearing aid using an apparatus, comprising: a unibody housing having at least one first recess configured to receive and store a used wax guard for a hearing aid and at least one second recess containing a new replacement wax guard for the hearing aid, the first recess and the second recess having a diameter from 5 mm-10 mm, the first recess having a fastener configured to receive and attach to the used wax guard. The housing may optionally have an ergonomic gripping surface, an easy-to-read first label identifying the first recess and an easy-to-read second label identifying the second recess, a rectilinear shape with the first recess on a first side and the second recess on a second side, a unitary body with no moving parts, and/or at least one air vent hole in communication with the first recess.

### BACKGROUND

Wax guards are small replaceable accessories for hearing aids that collect, trap, or block earwax, sebum, etc from migrating into the speaker transducer which can permanently compromise the acoustic output and frequency response of the system and its functionality. Current means used to replace these very small wax guard parts utilize very small, confusing and/or difficult to handle parts that are challenging for the end users who frequently have reduced vision, sense of feeling, strength, and dexterity in their hands or fingers. With traditional hearing aids dispensed through an audiologist, the wax guard is frequently changed by the audiologist rather than by the hearing aid wearer. With over the counter (OTC) hearing aids, an audiologist is no longer available to handle this process. The invention herein addresses these problems commonly experienced by hearing aid wearers by providing an improved means to remove dirty wax guards from a hearing aid and replace with a new, clean wax guard.

### SUMMARY

The invention relates to apparatuses and processes for replacing a used wax guard with a new wax guard for a hearing aid using an apparatus, comprising: a unibody housing having at least one first recess configured to receive and store a used wax guard for a hearing aid and at least one second recess containing a new replacement wax guard for the hearing aid, the first recess and the second recess having a diameter from 5 mm-10 mm, the first recess having a fastener configured to receive and attach to the used wax guard. The housing may optionally have an ergonomic gripping surface, an easy-to-read first label identifying the first recess and an easy-to-read second label identifying the second recess, a rectilinear shape with the first recess on a first side and the second recess on a second side, a unitary body with no moving parts, and/or at least one air vent hole in communication with the first recess.

An important feature of the invention, that provides a technical advantage and solving a problem, is that the invention solves the problem of poor eyesight, poor dexterity, and confusion commonly experienced by hearing aid users especially when they are changing the wax protection part.

### BRIEF DESCRIPTION OF THE FIGURES

FIG. 1 is a non-limiting illustration of a wax guard, according to the invention.

FIG. 2 is a non-limiting illustration of a wax guard kit showing a front side view, side view, and top view, according to the invention.

FIG. 3 is a non-limiting illustration of a wax guard kit showing a perspective view of the front and back side, according to the invention.

FIG. 4 is a non-limiting illustration of a wax guard kit showing a perspective view of the front and back side, according to the invention.

FIG. 5 is a non-limiting illustration of a wax guard kit showing alternate aspects, according to the invention.

FIG. 6 is a non-limiting illustration of a wax guard kit showing optional frangible lines, according to the invention.

FIG. 7 is a non-limiting illustration of a wax guard kit showing the process just prior to inserting a used wax guard from a hearing aid, according to the invention.

FIG. 8 is a non-limiting illustration of a wax guard kit showing the process of inserting a used wax guard from a hearing aid, according to the invention.

FIG. 9 is a non-limiting illustration of a wax guard kit in cross-section showing the process whereby a used wax guard from a hearing aid is seated into the disposal chamber, according to the invention.

FIG. 10 is a non-limiting illustration of a wax guard kit showing the deposit of the used wax guard in the disposal chamber and the withdrawal of the hearing aid earpiece, according to the invention.

FIG. 11 is a non-limiting illustration of a wax guard kit showing the insertion of the unguarded earpiece into the other end of the wax guard kit for seating a new wax guard in the hearing aid earpiece, according to the invention.

FIG. 12 is a non-limiting illustration of a wax guard kit showing a perspective view of a row of eight new wax guard seating chambers, according to the invention.

FIG. 13 is an illustration of a prior art device having a foldable stand for cleaning tips.

FIG. 14 is an illustration of a prior art device having a rotating disc for wax guards.

FIG. 15 is an illustration of a prior art device having a disc for wax guards.

FIG. 16 is an illustration of a prior art device having removable pods for wax guards.

### DETAILED DESCRIPTION

In a preferred embodiment, the invention provides an apparatus, comprising: a housing having at least one first recess configured to receive and store a used wax guard for a hearing aid and at least one second recess containing a new replacement wax guard for the hearing aid, the first recess and the second recess having a diameter from 5 mm-10 mm, the first recess having a fastener configured to receive and attach to the used wax guard.

Any of the embodiments herein may include wherein the housing has an ergonomic gripping surface.

Any of the embodiments herein may include wherein the housing has an easy-to-read first label identifying the first recess, and an easy-to-read second label identifying the second recess.

Any of the embodiments herein may include wherein the housing has a rectilinear shape, the first recess on a first side, the second recess on a second side.

Any of the embodiments herein may include wherein the housing has a unitary body and has no moving parts.

Any of the embodiments herein may include wherein the housing has at least one air vent hole in communication with the first recess.

Any of the embodiments herein may include wherein the housing has 6-12 first recesses, and has 6-12 second recesses.

Any of the embodiments herein may include wherein the housing has dimensions 30-55 mm height×35-60 mm length×5-10 mm width.

Any of the embodiments herein may include wherein the housing has at least one brush cavity for storing at least one removable cleaning brush.

Any of the embodiments herein may include wherein the housing has at least one tool cavity for storing at least one removable cleaning tool, wherein the removable cleaning tool is a small metal loop or rubber cleaning pick.

Any of the embodiments herein may include wherein the housing has an embedded magnet.

Any of the embodiments herein may include wherein the fastener is a tensioning fastener.

Any of the embodiments herein may include wherein the fastener is a torqueing fastener.

Any of the embodiments herein may include wherein the housing has a frangible portion, the frangible portion defined by at least one weakened line to remove the frangible portion from a remainder portion of the housing.

In another preferred embodiment claiming a different scope, the invention provides an apparatus, comprising: a housing having at least one first recess configured to receive and store a used wax guard for a hearing aid and at least one second recess containing a new replacement wax guard for the hearing aid, the first recess and the second recess having a diameter from 5 mm-10 mm, the first recess having a fastener configured to receive and attach to the used wax guard; wherein the housing has an ergonomic gripping surface; wherein the housing has an easy-to-read first label identifying the first recess, and an easy-to-read second label identifying the second recess; wherein the housing has a rectilinear shape, the first recess on a first side, the second recess on a second side; wherein the housing has a unitary body and has no moving parts; wherein the housing has at least one air vent hole in communication with the first recess.

Any of the alternate embodiments herein may include wherein the housing has 6-12 first recesses, and has 6-12 second recesses.

Any of the alternate embodiments herein may include wherein the housing has dimensions 30-55 mm height×35-60 mm length×5-10 mm width.

Any of the alternate embodiments herein may include wherein the housing has at least one brush cavity for storing at least one removable cleaning brush.

Any of the alternate embodiments herein may include wherein the housing has at least one tool cavity for storing at least one removable cleaning tool, wherein the removable cleaning tool is a small metal loop or rubber cleaning pick.

Any of the alternate embodiments herein may include wherein the housing has an embedded magnet.

Any of the alternate embodiments herein may include wherein the fastener is a tensioning fastener.

Any of the alternate embodiments herein may include wherein the fastener is a torqueing fastener.

Any of the alternate embodiments herein may include wherein the housing has a frangible portion, the frangible portion defined by at least one weakened line to remove the frangible portion from a remainder portion of the housing.

In another preferred embodiment, the invention provides a process, comprising the step or steps:
providing an apparatus, comprising a housing having at least one first recess configured to receive and store a used wax guard for a hearing aid and at least one second recess containing a new replacement wax guard for the hearing aid, the first recess and the second recess having a diameter from 5 mm-10 mm, the first recess having a fastener configured to receive and attach to the used wax guard;
inserting into the first recess a used wax guard mounted on a tip of the hearing aid until the fastener engages the used wax guard; and
inserting the tip of the hearing aid into the second recess to mount the new replacement wax guard onto the tip of the hearing aid.

Any of the processes may include the step of removing a frangible portion from a remainder portion of the housing, the frangible portion defined by at least one weakened line.

In another preferred embodiment, the invention provides a manufacturing process, comprising, in an apparatus comprising a housing having at least one first recess configured to receive and store a used wax guard for a hearing aid and at least one second recess configured to store a new replacement wax guard for the hearing aid, the first recess and the second recess having a diameter from 5 mm-10 mm, the first recess having a fastener configured to receive and attach to the used wax guard, the step of loading the new replacement wax guard into the second recess.

Any of the manufacturing processes may include one or more of the additional steps comprising: mounting on the housing an ergonomic gripping surface, attaching to the housing an easy-to-read first label identifying the first recess and an easy-to-read second label identifying the second recess, configuring the housing to have a rectilinear shape with the first recess on a first side and the second recess on a second side, configuring the housing to have a unitary body and substantially no moving parts, configuring the housing to have at least one air vent hole in communication with the first recess, and configuring the housing to have a frangible portion.

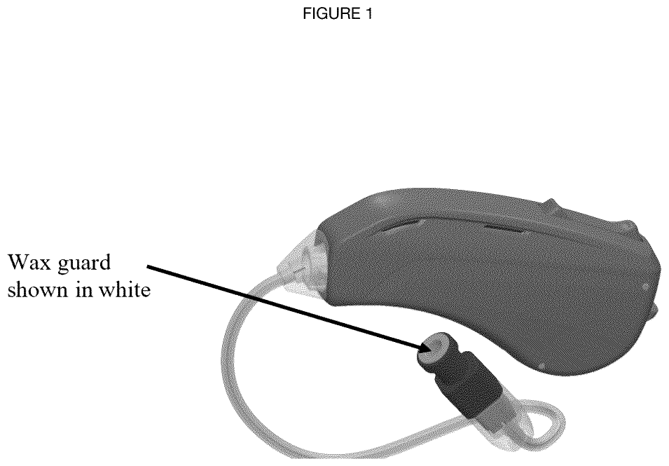

Referring now to the Figures, FIG. 1 shows the location of a wax guard in an earpiece in relation to a hearing aid having a sound delivery tube connected to a housing that contains the microphone, receiver, battery, amplifier, and any other electronics.

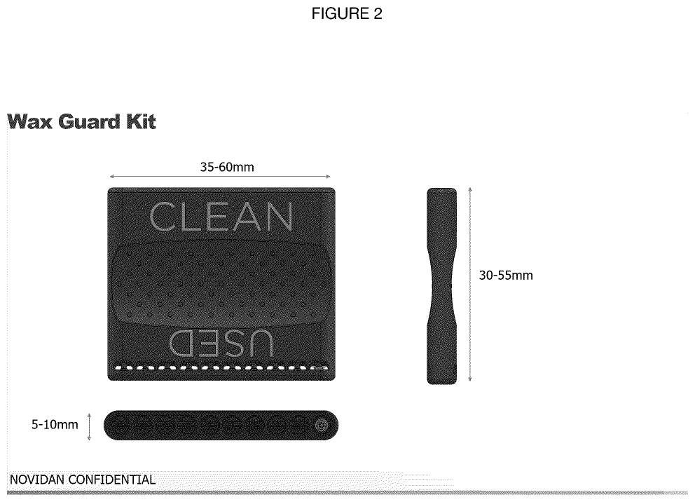

Referring now to FIG. 2, the invention utilizes a ergonomic size and shape (1st image and [E]) along with large and easy to read visual cues [C] [D] and contrasting colors (white/black) to help the user more easily handle and use the product to change out a dirty wax guard and replace it with a new one in their hearing aid [D & E]. It consists of a single part which doesn't require the user to open, close, or rotate small features to successfully use.

FIG. 2 illustrates that the invention is a device for replacing a used wax guard with a new wax guard for a hearing aid comprising: a unibody housing having at least one first recess configured to receive and store a used wax guard for a hearing aid and at least one second recess containing a new replacement wax guard for the hearing aid, the first recess and the second recess having a diameter from 5 mm-10 mm, the first recess having a fastener configured to receive and attach to the used wax guard. The housing may optionally have an ergonomic gripping surface, an easy-to-read first label identifying the first recess and an easy-to-read second label identifying the second recess, a rectilinear shape with the first recess on a first side and the second recess on a second side, a unitary body with no moving parts, and/or at least one air vent hole in communication with the first recess.

FIG. 2 shows that, in a non-limiting preferred embodiment, the device can be 35-60 mm in length, 30-55 mm in height, and 5-10 mm in width.

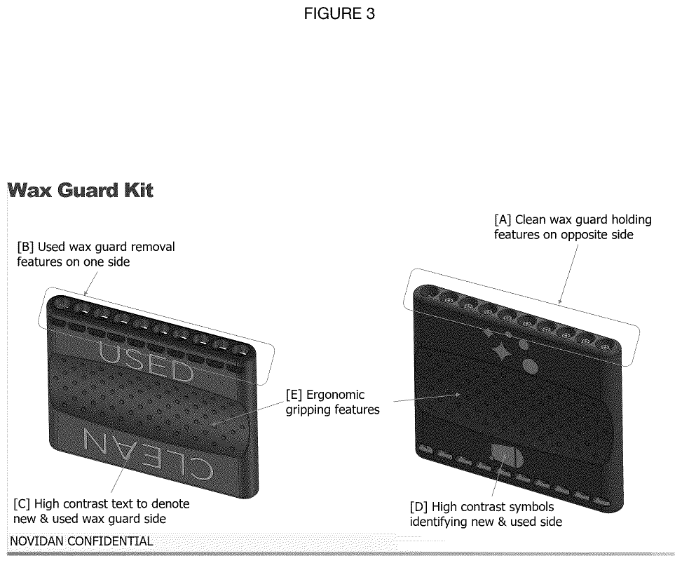

FIG. 3 shows a non-limiting illustration of a wax guard kit showing a perspective view of the front and back side, according to the invention. FIG. 3 shows the invention having up to ten (10) used wax guard removal features on one side, and up to ten (10) clean wax guard holding features (chambers) on the opposite side. FIG. 3 shows the invention having an ergonomic gripping feature as a curved recess with a textured surface. the gripping feature may be on one or on both sides of the device. FIG. 3 shows the invention having on one side a high contrast text/indicia to denote the new and used wax guard sides. FIG. 3 shows the invention having on an opposition side high contrast symbols identifying new and used wax guard sides.

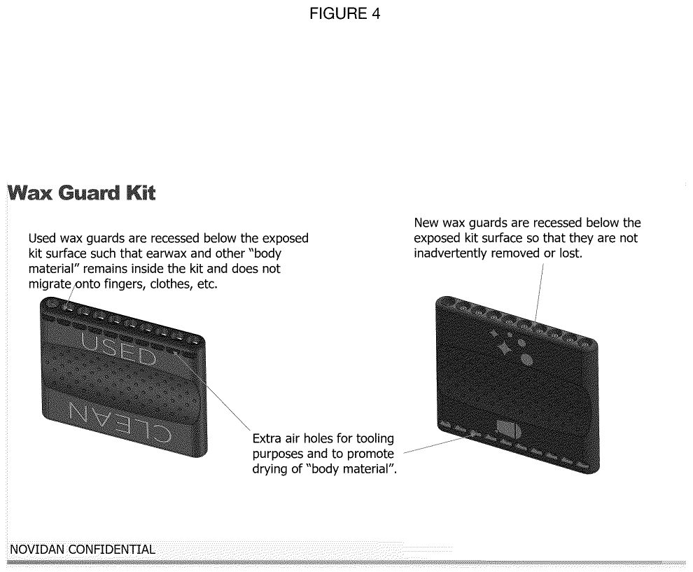

FIG. 4 shows that used wax guards are recessed below the exposed kit surface such that earwax or other unwanted debris materials remains inside the kit housing and does not migrate onto fingers, clothes, and surfaces. FIG. 4 shows that new wax guards are recessed below the exposed kit surface so that they are not inadvertently removed or lost. FIG. 4 shows extra air holes for tolling purposes and to promote the drying of wax and debris.

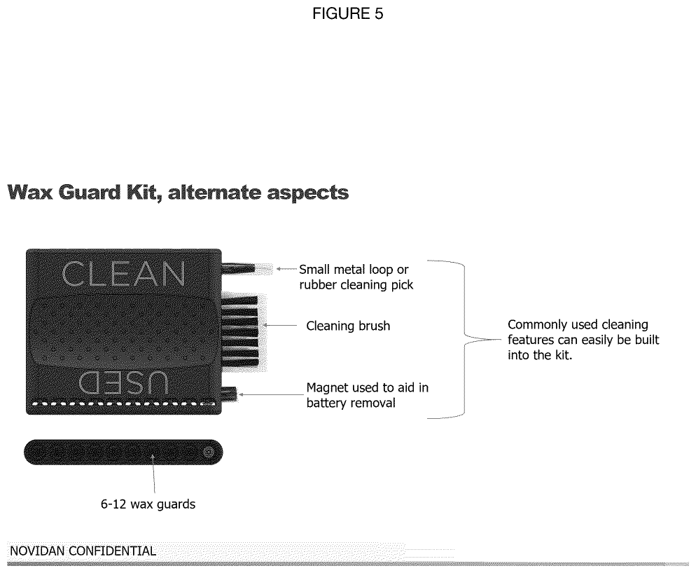

FIG. 5 shows that the invention in a non-limiting embodiment may include a small metal loop or rubber cleaning pick. In another alternate embodiment, the invention may include a cleaning brush. In another alternate embodiment, the invention may include a magnet used to assist in battery removal from the hearing aid housing. FIG. 5 shows that the invention may have from 6-12 wax guard chambers.

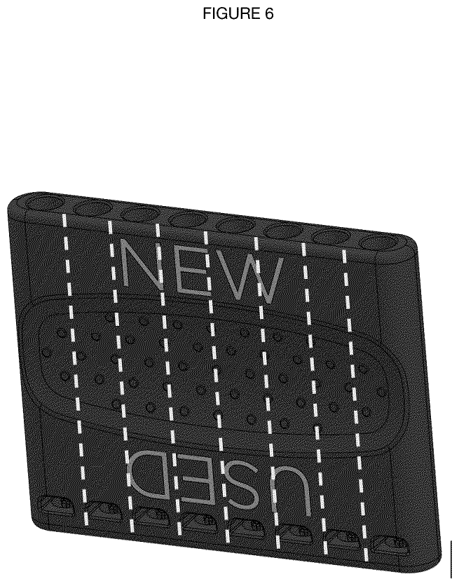

FIG. 6 shows that in an additional embodiment, each section of the tool can be designed such that when a wax guard is replaced, the entire dirty section can break away and be disposed. In this way, the user is not carrying or storing a tool covered in non-sanitary earwax or debris.

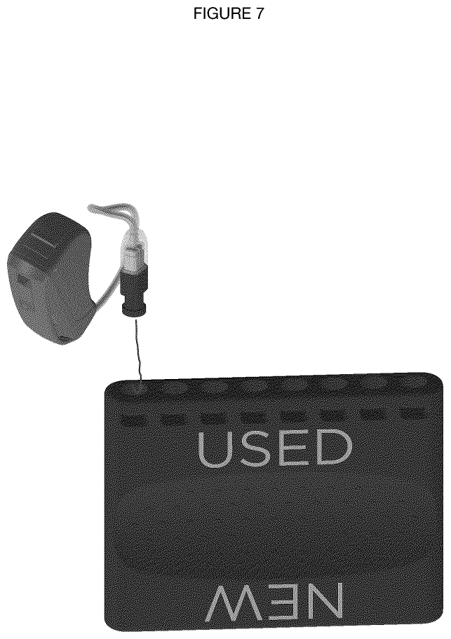

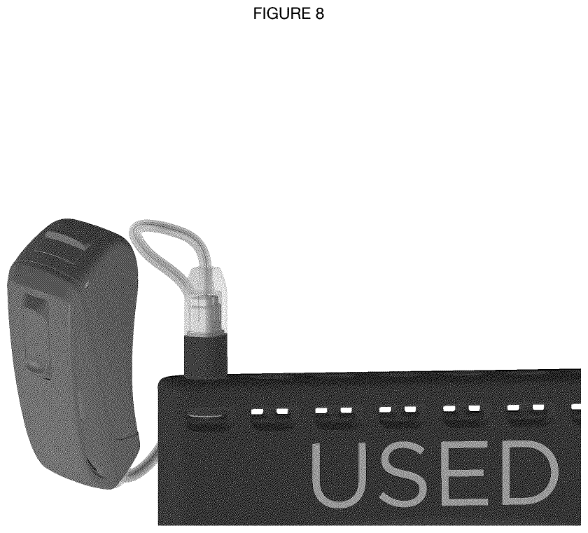

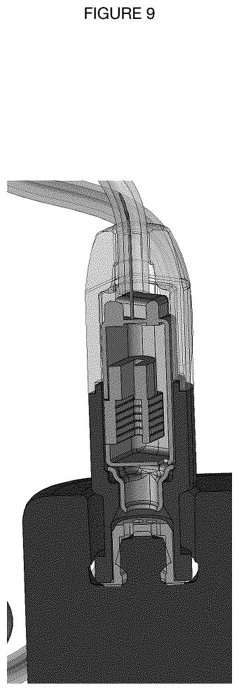

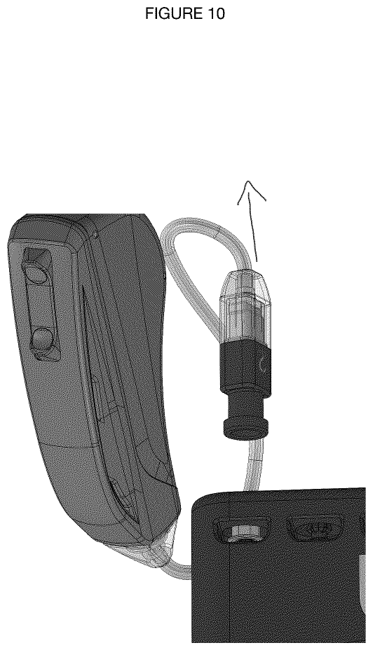

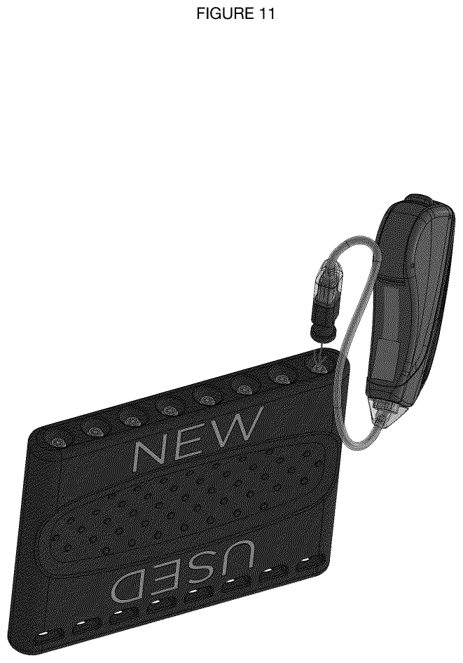

FIGS. 7-11 show the process of removing a used wax guard from an earpiece, and replacing it with a new clean wax guard. FIG. 7 shows that the process steps include: Insert hearing aid tip with dirty wax guard into “USED” side hole. FIG. 8 and FIG. 9 show that the wax guard snaps onto and remains attached to the removal feature when the hearing aid is removed. FIG. 10 shows the replacement of a new wax guard. FIGS. 10-11 show the process of inserting the tip into a hole of the “NEW” side. Upon removal of the hearing aid, a new, clean wax guard is now placed into the hearing aid tip.

In additional embodiments, the new wax guards could be placed in the body of the hearing aid or in the carrying case as another means to have a replacement mechanism that doesn't use individual sticks or a separate wheel.

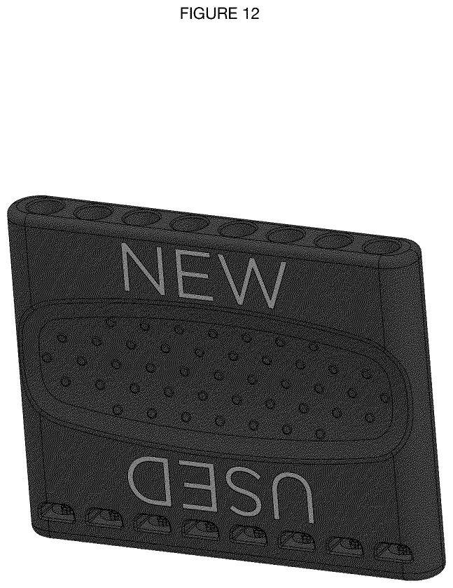

FIG. 12 shows that the new, replacement wax guards are press-fit into one side of the removal tool in a mechanism-free part involved in this invention. This device works when a person with the previously mentioned limitations is able to easily remove a dirty wax guard from their hearing aid and replace it with a new and clean wax guard.

In additional embodiments, new wax guards are housed within holes in the hearing aid body. New wax guards may also be housed within the hearing aid carrying case using similar features that do not require manipulating very small parts or mechanisms.

### PARTS

For explaining the figures, the following suggested parts may be useful.
100 new wax guard kit for a hearing aid
102 a unibody housing
104 at least one first recess configured to receive and store
106 a used wax guard
108 a hearing aid
110 at least one second recess
112 a new replacement wax guard for the hearing aid
114 a diameter from 5 mm-10 mm for the first recess and the second recess
116 a fastener in the first recess having configured to receive and attach to the used wax guard.

The housing may optionally have
118 an ergonomic gripping surface,
120 an easy-to-read first label identifying the first recess,
122 an easy-to-read second label identifying the second recess,
124 a rectilinear shape
126 a first recess on a first side and
128 a second recess on a second side, and
130 at least one air vent hole in communication with the first recess.

### MATERIALS

The invention may be manufactured from most common kinds of plastic including low density polyethylene (LDPE), high density polyethylene (HDPE), Polypropylene (PP), Polyvinyl chloride (PVC), Polystyrene (PS), Neoprene, Nylon, nylon 6, nylon 6,6, Teflon (Polytetrafluoroethylene), thermoplastic polyurethanes (TPU), fiberglass reinforced polyester (FRP), carbon fiber, polyamide, polyimide, polycarbonate, acrylic polymer, polyester, rubber/latex polymer, rotationally molded polyethylene or linear low density polyethylene (LLDPE). Without limiting the invention, blow molding and rotational molding are two kinds of molding processes used to create plastic cases. When materials are used in combination, together the materials can be used to form a very strong and stiff substance that is then molded through heat or compression into shape during composite molding. Additionally, matrix reinforced fibers may be used while being molded into a form. In additional embodiments, the device may include a metal frame to provide support and structure.

### Color Indicia

In an additional embodiment, the device housing may used colored materials. In one non-limiting example, the used wax guard side is a different color than the new wax guard side. In another non-limiting example, the housing may include alternating or differing longitudinal color stripes to highlight the vertical location of a top and bottom set of used and new wax guards.

### Snap Tight/Haptic Feedback

In an additional embodiment, the process of depositing the used wax guard into a disposal chamber and/or the process of seating a new wax guard onto an earpiece includes a haptic feedback, or a snap. While a hearing aid is being serviced, it is not installed in the persons ear. The use of a flange or collar within the disposal chamber or within the new wax guard seating chamber to provide a touch or snap feedback to the user provides a mechanism for ensuring the replacement is performed successfully.

### Comparative Examples

Prior art devices do not work well as they can be confusing for the user or if the placement or replacement of wax guards is unsuccessful.

The prior art, e.g. USRE45455E1, WO1997009864A1 focuses mainly on the wax guard itself rather than the method or tools used to place and remove them from the hearing aid. There are some sketches of the stick method for wax guard placement and removal.

Current products can be used to place and remove wax guards, but the invention solves the difficulty that users experience in using small existing tools by providing a more ergonomic and easy-to-handle design that does not require actuating a mechanism to remove and replace wax guards in a hearing aid.

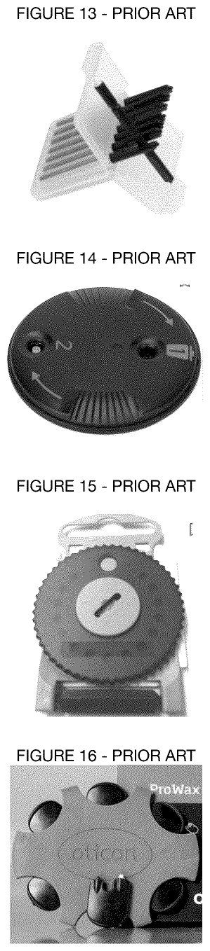

FIG. 13 shows a comparative example of sticks with a case. Here the sticks are difficult to handle and are very small and hard to see. It is a tricky task for users to remove the sticks from the case one-at-a-time without pinching multiple sticks. Multiple parts increase the cost and complexity of this replacement system.

FIG. 14 shows a comparative example of a disk. This device requires much more user interaction to rotate the top side cover and expose the clean and dirty wax guards. All clean wax guards are hidden from the user which makes it tricky to know how many clean wax guards remain. Multiple parts increase the cost and complexity of this replacement system.

FIG. 15 shows a comparative example of a wheel. This device requires much more user interaction to rotate the cover and expose the clean wax guards. A second step requires the user to remove the small application/removal tool much like the sticks and case idea. In this instance, the user will have to then remove the dirty wax guard from the stick and dispose of it without also disposing of the application tool. Multiple parts increase the cost and complexity of this replacement system.

FIG. 16 shows a comparative example of a horseshoe with case. This idea is like the sticks but with a different shape. The small parts are still very difficult to handle and see for hearing aid users. It is a tricky task for users to remove the sticks from the case. Multiple parts increase the cost and complexity of this replacement system.

Terms—The terminology used herein is for the purpose of describing particular embodiments only and is not intended to limit the full scope of the claims. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention.

Plural—As used herein, the singular forms “a”, “an” and “the” are intended to include the plural forms as well, unless the context clearly indicates otherwise. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Claims—In general, terms used herein, and especially in the appended claims (e.g., bodies of the appended claims) are generally intended as “open” terms (e.g., the term “including” should be interpreted as “including but not limited to,” the term “having” should be interpreted as “having at least,” etc.). Similarly, the terms “comprises” and/or “comprising,” when used in this specification, specify the presence of stated features, integers (or fractions thereof), steps, operations, elements, and/or components, but do not preclude the presence or addition of one or more other features, integers (or fractions thereof), steps, operations, elements, components, and/or groups thereof. As used in this document, the term “comprising” means “including, but not limited to.”

Combinations—As used herein the term “and/or” includes any and all combinations of one or more of the associated listed items. It should be understood that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Ranges-All ranges disclosed herein also encompass any and all possible subranges and combinations of subranges thereof unless expressly stated otherwise. Any listed range should be recognized as sufficiently describing and enabling the same range being broken down into at least equal subparts unless expressly stated otherwise. As will be understood by one skilled in the art, a range includes each individual member.

Illustrations—The embodiments herein, and/or the various features or advantageous details thereof, are explained more fully with reference to the non-limiting embodiments that are illustrated in the accompanying drawings and detailed in the following description. Descriptions of well-known components and processing techniques are omitted so as to not unnecessarily obscure the embodiments herein. Like numbers refer to like elements throughout.

Examples—The examples and/or embodiments described herein are intended merely to facilitate an understanding of structures, functions, and/or aspects of the embodiments, ways in which the embodiments may be practiced, and/or to further enable those skilled in the art to practice the embodiments herein. Similarly, methods and/or ways of using the embodiments described herein are provided by way of example only and not limitation. Specific uses described herein are not provided to the exclusion of other uses unless the context expressly states otherwise.

Modifications-Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited, unless so stated, to particular methods, order of processing steps, components, materials, systems, partial aspects of processes, components or systems, uses, compounds, compositions, standards, routines, and modes, which can, of course, vary. It is also to be understood that the terminology used herein is for the purpose of describing particular embodiments only, and is not intended to be limiting unless specifically stated.

What is claimed as the invention is:

1. An apparatus, comprising:
a housing having at least one first recess configured to receive and store a used wax guard for a hearing aid and at least one second recess containing a new replacement wax guard for the hearing aid, the first recess and the second recess having a diameter from 5 mm-10 mm, the first recess having a fastener configured to receive and attach to the used wax guard.

2. The apparatus of claim 1, wherein the housing has an ergonomic gripping surface.

3. The apparatus of claim 1, wherein the housing has an easy-to-read first label identifying the first recess, and an easy-to-read second label identifying the second recess.

4. The apparatus of claim 1, wherein the housing has a rectilinear shape, the first recess on a first side, the second recess on a second side.

5. The apparatus of claim 1, wherein the housing has a unitary body and has no moving parts.

6. The apparatus of claim 1, wherein the housing has at least one air vent hole in communication with the first recess.

7. The apparatus of claim 1, wherein the housing has 6-12 first recesses, and has 6-12 second recesses.

8. The apparatus of claim 1, wherein the housing has dimensions 30-55 mm height×35-60 mm length×5-10 mm width.

9. The apparatus of claim 1, wherein the housing has at least one brush cavity for storing at least one removable cleaning brush.

10. The apparatus of claim 1, wherein the housing has at least one tool cavity for storing at least one removable cleaning tool, wherein the removable cleaning tool is a small metal loop or rubber cleaning pick.

11. The apparatus of claim 1, wherein the housing has an embedded magnet.

12. The apparatus of claim 1, wherein the fastener is a tensioning fastener.

13. The apparatus of claim 1, wherein the fastener is a torqueing fastener.

14. The apparatus of claim 1, wherein the housing has a frangible portion, the frangible portion defined by at least one weakened line to remove the frangible portion from a remainder portion of the housing.

15. An apparatus, comprising:
a housing having at least one first recess configured to receive and store a used wax guard for a hearing aid and at least one second recess containing a new replacement wax guard for the hearing aid, the first recess and the second recess having a diameter from 5 mm-10 mm, the first recess having a fastener configured to receive and attach to the used wax guard;
wherein the housing has an ergonomic gripping surface;
wherein the housing has an easy-to-read first label identifying the first recess, and an easy-to-read second label identifying the second recess;
wherein the housing has a rectilinear shape, the first recess on a first side, the second recess on a second side;
wherein the housing has a unitary body and has no moving parts;
wherein the housing has at least one air vent hole in communication with the first recess.

16. The apparatus of claim 15, wherein the housing has 6-12 first recesses, and has 6-12 second recesses.

17. The apparatus of claim 15, wherein the housing has dimensions 30-55 mm height×35-60 mm length×5-10 mm width.

18. The apparatus of claim 15, wherein the housing has at least one brush cavity for storing at least one removable cleaning brush.

19. The apparatus of claim 15, wherein the housing has at least one tool cavity for storing at least one removable cleaning tool, wherein the removable cleaning tool is a small metal loop or rubber cleaning pick.

20. The apparatus of claim 15, wherein the housing has an embedded magnet.

21. The apparatus of claim 15, wherein the fastener is a tensioning fastener.

22. The apparatus of claim 15, wherein the fastener is a torqueing fastener.

23. The apparatus of claim 15, wherein the housing has a frangible portion, the frangible portion defined by at least one weakened line to remove the frangible portion from a remainder portion of the housing.

24. A process, comprising:
providing an apparatus, comprising a housing having at least one first recess configured to receive and store a used wax guard for a hearing aid and at least one second recess containing a new replacement wax guard for the hearing aid, the first recess and the second recess having a diameter from 5 mm-10 mm, the first recess having a fastener configured to receive and attach to the used wax guard;
inserting into the first recess a used wax guard mounted on a tip of the hearing aid until the fastener engages the used wax guard; and
inserting the tip of the hearing aid into the second recess to mount the new replacement wax guard onto the tip of the hearing aid.

25. The process of claim 24, comprising the step of removing a frangible portion from a remainder portion of the housing, the frangible portion defined by at least one weakened line.

26. A manufacturing processing, comprising:
in an apparatus comprising a housing having at least one first recess configured to receive and store a used wax guard for a hearing aid and at least one second recess configured to store a new replacement wax guard for the hearing aid, the first recess and the second recess having a diameter from 5 mm-10 mm, the first recess having a fastener configured to receive and attach to the used wax guard,
the step of loading the new replacement wax guard into the second recess.

27. The manufacturing process of claim 26, comprising:
wherein the housing has an ergonomic gripping surface,
wherein the housing has an easy-to-read first label identifying the first recess, and an easy-to-read second label identifying the second recess,
wherein the housing has a rectilinear shape, the first recess on a first side, the second recess on a second side,
wherein the housing has a unitary body and has no moving parts, and
wherein the housing has at least one air vent hole in communication with the first recess.
